(19) United States
(12) Patent Application Publication
(10) Pub. No.: US 2015/0364050 A1
(43) Pub. Date: Dec. 17, 2015

(54) COMPUTER-IMPLEMENTED CONTENT REPOSITORY AND DELIVERY SYSTEM FOR ONLINE LEARNING

(71) Applicant: Better AG, Zurich (CH)

(72) Inventors: Carl Baatz, Zurich (CH); Jan Sramek, Zurich (CH)

(21) Appl. No.: 14/302,335

(22) Filed: Jun. 11, 2014

(51) Int. Cl. G09B 5/12; G06Q 50/20

(52) U.S. Cl. CPC G09B 5/12; G06Q 50/205

(57) ABSTRACT

A computer-implemented content repository and delivery system for online learning comprises an authoring module, a learner database, and a runtime engine. The authoring module stores in the content repository learning content and assessment definition data received from an author for a course unit of an online course. The learner database stores assessment responses that determine a learner's level of achievement in course units. Responsive to a learning request for a particular learner and online course, the runtime engine retrieves from the learner database assessment responses, selects in the content repository for the learner's level of achievement a course unit of the requested online course, and delivers the learning content to the learner. Using the assessment definition data, the runtime engine performs an assessment of the learner's level of achievement in the course unit and updates the learner database.

### BACKGROUND

1. Field of the Invention

The present invention relates to a computer-implemented content repository and delivery system. Specifically, the present invention relates to a computer-implemented content repository and delivery system for online learning and to a computer-implemented method of storing and delivering content for online learning.

2. Description of the Related Art

With the increased integration, availability, and affordable bandwidth of the Internet, online learning has become more attractive and popular—not only for university and college education but also for other private and public schools as well as for training programs of companies and government institutions. Likewise, it has become feasible to prepare learning content for online courses via the Internet by a plurality of contributing authors. However, while this distributed and collaborative approach has introduced several difficulties and challenges, it has not delivered on its promise of increased efficiency, flexibility, and quality. Particularly, there is a difficulty in effective and efficient management of online courses throughout their lifecycle, i.e. from (collaborative) creation to delivery to subsequent analysis of the results. Primarily, this is caused by the fact that in most cases an online course is essentially defined as a combination of Flash or HTML files, which combine the learning content, interface design, and learning logic without regard for any semantic meaning or appropriate abstractions. Consequently, defining and generating an online course still requires a large overhead for coordinating the collaborative effort from a plurality of authors with regards to new and updated content contributions, with no or very limited maintainability and reusability of these contributions. In addition, these drawbacks are aggravated significantly, if online courses are to be offered in different languages.

### SUMMARY

It is an object of this invention to provide a computer-implemented content repository and delivery system and a computer-implemented method of storing and delivering content, which system and method do not have at least some of the disadvantages of the prior art. In particular, it is an object of the present invention to provide a computer-implemented content repository and delivery system for online learning and a computer-implemented method of storing and delivering content for online learning.

According to the present invention, these objects are achieved through the features of the independent claims. In addition, further advantageous embodiments follow from the dependent claims and the description.

According to the present invention, the above-mentioned objects are particularly achieved in that a computer-implemented content repository and delivery system for online learning comprises an authoring module, a learner database, and a runtime engine. The authoring module is configured to receive from an author via a telecommunications network learning content and assessment definition data for a course unit of an online course. The assessment definition data defines assessment questions and evaluation criteria for assessing a learner's level of achievement with regards to the course unit. The authoring module is further configured to store the course unit, including the learning content and the assessment definition data, in the content repository as a part of the online course assigned to a course identifier of the online course. The learner database is configured to store for a learner assessment result data assigned to a learner identifier of the learner. The assessment result data determines a learner's level of achievement in course units of the respective online course. The runtime engine is configured to receive via the telecommunications network a learning request including a particular learner identifier of a particular learner and a particular course identifier. The runtime engine is further configured to retrieve from the learner database assessment result data assigned to the particular learner identifier, to select in the content repository for the particular learner's level of achievement, as determined by the assessment result data retrieved from the learner database, a course unit that is assigned to the particular course identifier. The runtime engine is further configured to deliver to the learner via the telecommunications network the learning content of the course unit selected in the content repository, to perform an assessment of the learner's level of achievement in the course unit using the respective assessment definition data, and to update in the learner database the assessment result data for the learner, depending on the assessment.

Enabling an author to define and transmit to a computer-implemented content repository and delivery system course units that include in each case learning content and assessment definition data specific for the respective course unit, makes it possible to generate a plurality of course units independently from each other, possibly by several authors concurrently and without any interdependencies, while still making it possible to generate well-structured and organized online courses that include several of these course units which can only be accessed by a learner who has a sufficient level of achievement. Thus, providing user interfaces and data structures that are configured to include in a course unit not only learning content but also assessment definition data for the course unit makes it possible to generate online learning courses with several course units that are interdependent with regards to their accessibility to a learner, without the necessity of having to coordinate and define such interdependencies externally to an individual course unit, i.e. outside the scope and context of a course unit, at a higher level of an online learning course. In other words, the technical conception and design of the user interfaces and data structures enable a collaborative and flexible approach for defining and generating online learning courses concurrently and independently by several authors, without the need for complex collaboration and communication protocols for governing interdependencies among several authors working on an online learning course that would otherwise not only put an additional data traffic load on communication networks but also reduce efficiency and flexibility of defining and generating online learning courses.

In an embodiment the runtime engine is configured to store in the learner database as part of the assessment result data for a course unit a learner's responses to assessment questions with regards to the course unit, and to infer from the learner's responses included in the assessment result data retrieved from the learner database the learner's level of achievement, using the evaluation criteria included in the assessment definition data; particularly, the evaluation criteria included in the assessment definition data for the course unit. Storing the learner's responses makes it possible to dynamically infer and derive the learner's level of achievement at any point in time with possibly varying and new evaluation criteria. Rather than merely storing a quantitative evaluation result, e.g. a grade or other derived measure, storing the learner's responses has the further advantages of enabling a selection of more specific and effective remedial exercises and feedback for the learner, at any (future) point in time and across various course units and even different online courses, and making possible flexible analysis of a plurality of learners' responses and mistakes that can be used to improve the course units and online courses with adapted and/or additional lessons. Generally, storing the learners' responses makes it possible to reuse and rely on previously gathered assessment data at future points in time with improved and extended assessment, evaluation and analysis capabilities and algorithms of the content repository and delivery system and its runtime engine. Moreover, the stored responses make it possible to test and calibrate such extensions and improvements of the content repository and delivery system and its runtime engine.

In a further embodiment, the authoring module is configured to store the course unit as a self-contained data object, and to store an online course as a data structure including references to a plurality of course units, i.e. to a plurality of self-contained data objects. Defining and structuring an online course based on references to self-contained course units has the advantage that individual course units may be changed efficiently and flexibly, without having to make any changes to the definition and structure of the online course or of any external systems or entities that access and use the online course. Moreover, to provide an online course in different languages, depending on the embodiment, course units are provided as different data objects in these different languages or course units include in their respective data object learning content and assessment definition data in these different languages.

In another embodiment, the authoring module is further configured to receive from an author via the telecommunications network a request for including in a particular online course an already existing course unit which is stored in the content repository as a part of another online course, and to store the already existing course unit in the content repository further as a part of the particular online course assigned to a course identifier of the particular online course. Defining and structuring an online course based on references to self-contained course units and allowing the self-contained course units to be part of and referenced by more than one online course makes it possible to efficiently use and reuse the same course unit in a variety of different online courses, while ensuring that changes and updates to a course unit are reflected automatically in all these online courses, without any further effort being required for that effect.

In yet a further embodiment, the authoring module is further configured to receive from an author via the telecommunications network a request for adding to or deleting from a particular online course a particular course unit, and to store in the content repository a structure of the particular online course with the particular course unit added or removed, respectively. Enabling an online course to be altered by adding or removing references to self-contained course units makes it possible to flexibly and efficiently adapt and extend an online course, without having to make or coordinate any changes to course units or any external systems or entities that access and use the online course.

In another embodiment, the authoring module is configured to receive from the author via the telecommunications network prerequisite data for a course unit of an online course, the prerequisite data defining prerequisites for the course unit, and to store the course unit including the prerequisite data in the content repository as a part of the online course. The runtime engine is configured to select in the content repository a course unit, which is assigned to the particular course identifier and includes prerequisite data defining prerequisites that are met by the particular learner's level of achievement as determined by the assessment result data retrieved from the learner database. In a variant, the independence of defining and generating individual course units is maintained by the prerequisite data defining intra-unit prerequisites, i.e. prerequisites for sub-units of the course unit (e.g. a defined level of achievement on specific sub-units), or generic inter-unit prerequisites that relate to defined subjects, topics, themes, or categories of learning content (e.g. a defined level of achievement on one or more specific subject).

In an embodiment, the system further comprises a communication module configured to transmit to a learning management system via the telecommunications network a list of one or more course identifiers of online courses, to receive from the learning management system via the telecommunications network a selection of a particular online course included in the list, and to transmit to the learning management system via the telecommunications network an access data object configured to enable a learner's communication terminal to transmit to the runtime engine via the telecommunications network a learning request including a course identifier of the particular online course.

In addition to the computer-implemented content repository and delivery system, the present invention also relates to a computer-implemented method of storing and delivering content for online learning. The method comprises receiving in a computer-implemented content repository and delivery system from an author via a telecommunications network learning content and assessment definition data for a course unit of an online course. The assessment definition data defines assessment questions and evaluation criteria for assessing a learner's level of achievement with regards to the course unit. The method further comprises storing in the content repository the course unit including the learning content and the assessment definition data as a part of the online course assigned to a course identifier of the online course. The method further comprises storing for a learner in a learner database of the computer-implemented content repository and delivery system assessment result data assigned to a learner identifier of the learner. The assessment result data determines a learner's level of achievement in course units of the respective online course. The method further comprises receiving by a runtime engine of the computer-implemented content repository and delivery system via the telecommunications network a learning request including a particular learner identifier of a particular learner and a particular course identifier; retrieving by the runtime engine from the learner database assessment result data assigned to the particular learner identifier; selecting by the runtime engine in the content repository for the particular learner's level of achievement, as determined by the assessment result data retrieved from the learner database, a course unit which is assigned to the particular course identifier; delivering by the runtime engine to the learner via the telecommunications network the learning content of the course unit selected in the content repository; performing by the runtime engine an assessment of the learner's level of achievement in the course unit using the respective assessment definition data; and updating by the runtime engine in the learner database the assessment result data for the learner, depending on the assessment.

In an embodiment, the method further comprises the runtime engine storing in the learner database as part of the assessment result data for a course unit a learner's responses to assessment questions with regards to the course unit. The method further comprises the runtime engine inferring from the learner's responses included in the assessment result data retrieved from the learner database the learner's level of achievement, using the evaluation criteria included in the assessment definition data; particularly, the evaluation criteria included in the assessment definition data for the course unit.

In a further embodiment, the method comprises storing the course unit in the content repository as a self-contained data object, and storing the online course as a data structure including references to a plurality of course units.

In another embodiment, the method further comprises the computer-implemented content repository and delivery system receiving from an author via the telecommunications network a request for including in a particular online course an already existing course unit which is stored in the content repository as a part of another online course, and storing the already existing course unit in the content repository further as a part of the particular online course assigned to a course identifier of the particular online course.

In yet a further embodiment, the method further comprises the computer-implemented content repository and delivery system receiving from an author via the telecommunications network a request for adding to or deleting from a particular online course a particular course unit, and storing in the content repository a structure of the particular online course with the particular course unit added or removed, respectively.

In another embodiment, the method further comprises the authoring module receiving from the author via the telecommunications network prerequisite data for a course unit of an online course, the prerequisite data defining prerequisites for the course unit, the authoring module storing the course unit including the prerequisite data in the content repository as a part of the online course, and the runtime engine selecting in the content repository a course unit which is assigned to the particular course identifier and includes prerequisite data defining prerequisites that are met by the particular learner's level of achievement as determined by the assessment result data retrieved from the learner database

In an embodiment, the method further comprises the computer-implemented content repository and delivery system transmitting to a learning management system via the telecommunications network a list of one or more course identifiers of online courses, receiving from the learning management system via the telecommunications network a selection of a particular online course included in the list, and transmitting to the learning management system via the telecommunications network an access data object configured to enable a learner's communication terminal to transmit to the runtime engine via the telecommunications network a learning request including a course identifier of the particular online course.

In addition to the computer-implemented content repository and delivery system and the computer-implemented method of storing and delivering content for online learning, the present invention also relates to a computer program product comprising a non-transient computer readable medium having stored therein computer program code. The computer program code is configured to control a processor of a computer-implemented content repository and delivery system, such that the computer-implemented content repository and delivery system performs various steps for storing and delivering content for online learning. These steps comprise receiving from an author via a telecommunications network learning content and assessment definition data for a course unit of an online course. The assessment definition data defines assessment questions and evaluation criteria for assessing a learner's level of achievement with regards to the course unit. The steps further comprise storing in the content repository the course unit, including the learning content and the assessment definition data, as a part of the online course assigned to a course identifier of the online course. The steps further comprise storing for a learner in a learner database assessment result data assigned to a learner identifier of the learner. The assessment result data determines a learner's level of achievement in course units of the respective online course. The steps further comprise receiving via the telecommunications network a learning request including a particular learner identifier of a particular learner and a particular course identifier. The steps further comprise retrieving from the learner database assessment result data assigned to the particular learner identifier, and selecting in the content repository for the particular learner's level of achievement, as determined by the assessment result data retrieved from the learner database, a course unit which is assigned to the particular course identifier. The steps further comprise delivering to the learner via the telecommunications network the learning content of the course unit selected in the content repository; performing an assessment of the learner's level of achievement in the course unit using the respective assessment definition data; and updating in the learner database the assessment result data for the learner, depending on the assessment.

### BRIEF DESCRIPTION OF THE DRAWINGS

The present invention will be explained in more detail, by way of example, with reference to the drawings in which:

FIG. 1: shows a block diagram illustrating schematically a computer-implemented content repository and delivery system for online learning, accessible for authors and learners via a telecommunications network;

FIG. 2: shows a block diagram illustrating schematically a content repository comprising online courses and associated course units;

FIG. 3: shows a block diagram illustrating schematically a content repository with course units and a learner database with learners' assessment result data associated with the course units; and

FIG. 4: shows a flow diagram illustrating an exemplary sequence of steps for storing and delivering content for online learning.

### DETAILED DESCRIPTION

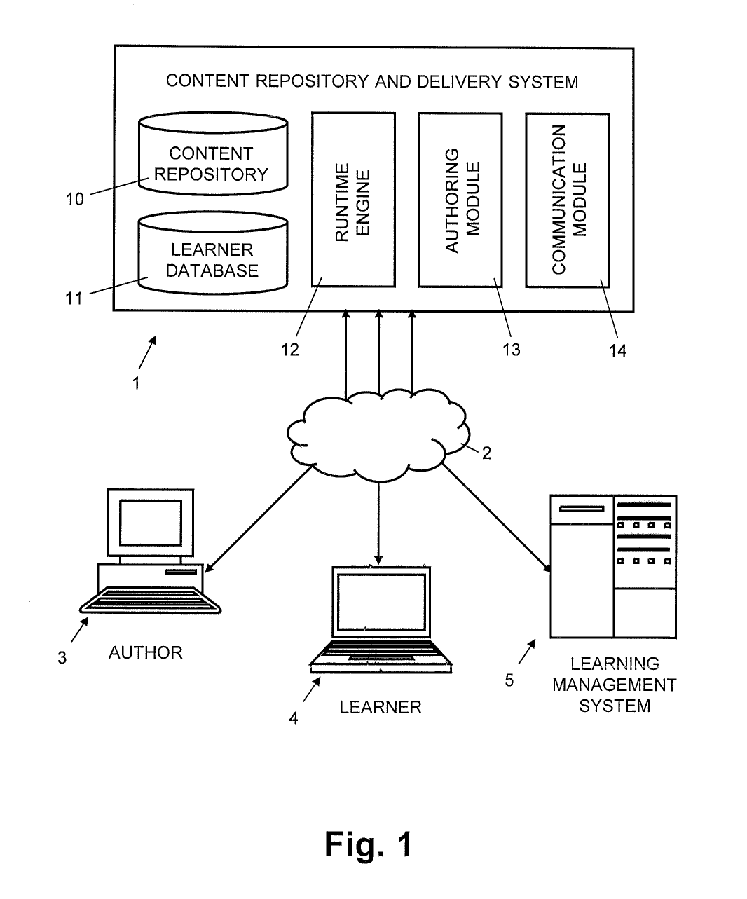

In FIG. 1, reference numeral 1 refers to a computer-implemented content repository and delivery system, particularly a computer-implemented content repository and delivery system 1 for online learning. The content repository and delivery system 1 comprises one or more operable computers, each having one or more processors as well as data and program storage systems. The content repository and delivery system 1 is accessible to remote communication terminals and/or computer systems 3, 4 of authors and learners as well as to remote computerized learning management systems 5 via a telecommunications network 2. The telecommunications network 2 includes the Internet accessible to the remote communication terminals and/or computer systems 3, 4 of authors and learners through fixed networks and/or wireless networks, such as mobile radio telephone systems and/or wireless local area networks (WLAN). The communication terminals and/or computer systems 3, 4 of authors and learners include personal desktop or notebook computers, tablet computers, mobile radio telephones, or similar computing and communication devices.

As illustrated schematically in FIG. 1, the content repository and delivery system 1 includes various data storage systems and functional modules. The data storage systems include a content repository 10 and a learner database 11. The functional modules include a runtime engine 12, an authoring module 13, and a communication module 14. The functional modules include computer program code configured to control the processors or computers, respectively, of the content repository and delivery system 1 to execute various functions, as will be explained later in more detail. The computer program code is stored on a non-transient computer-readable medium which is connected in a fixed or removable fashion to processors or computers, respectively, of the content repository and delivery system 1.

The communication module 14 is configured to exchange data via telecommunications network 2 with remote communication terminals and/or computer systems 3, 4 of authors and learners as well as with one or more remote computerized learning management systems 5.

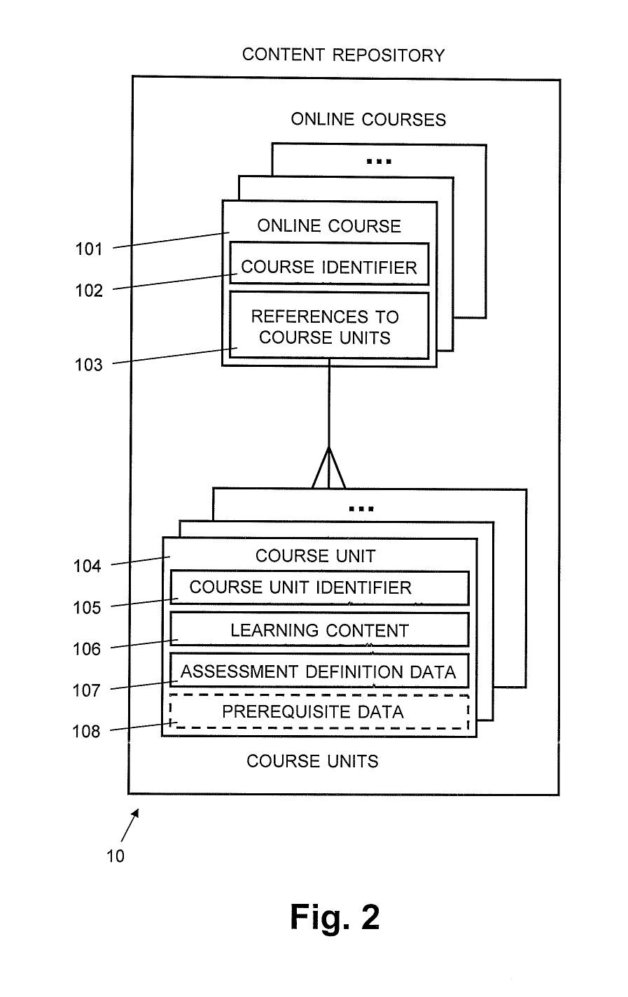

As illustrated in FIG. 2, the content repository 10 includes one or more online courses 101. Each of the online courses 101 includes a course identifier 102 identifying the online course and references 103 to one or more course units 104. Depending on the embodiment, the online courses 101 include further data, particularly, meta data such as configurations and settings for instructional methods used in the respective online course 101.

Each of the course units 104 includes a course unit identifier 105, learning content 106, and assessment definition data 107. Optionally, the course units 104 further include prerequisite data 108. The course identifiers 103 and the course unit identifiers 105 include a unique identifier part, e.g. an alphanumeric code, and an optional descriptive part, e.g. a title. The online courses 101 and the course units 104 include further data such as version number, creation data, release data, abstract, and/or author, etc. The course units 104 are stored as self-contained data objects.

The course units 104 are configured to be transferred and processed as self-contained data objects. The online courses 101 and their associated course units 104 can be organized in different course structures that are selectable by the authors or course editors. The course structures include, for example, sequential list, tree structure, directed graphs, etc., where the course units 104 or their references 103, respectively, are items or nodes in these structures. The course structure defines the order of course units 104 and/or the prerequisites of the course units 104. In an embodiment, the course units 104 include further or alternative prerequisite data 108. The prerequisite data 108 defines a learner's minimum level of achievement that is required to take or make accessible a particular course unit 104 or a particular sub-unit of the respective course unit 104. Depending on the embodiment or implementation, the prerequisite data 108 defines a learner's minimum level of achievement with regards to one or more defined subjects (e.g. from a list of defined subjects or subject categories) and/or one or more specific course units 104.

The learning content 106 includes multimedia content such as text, graphs, pictures, photos, audio, video, and/or other digital media as outlined in the introduction.

The assessment definition data 107 includes assessment questions with regards to the respective course unit 104. The assessment questions may request answers from the learner in form of multiple choice or text. The assessment definition data 107 further includes evaluation criteria for assessing a learner's level of achievement with regards to the course unit 104. Specifically, the evaluation criteria define rules, algorithms, and/or weighting factors for deriving and inferring from the learner's responses to the assessment questions, the learner's level of achievement, e.g. in terms of a grade or percentage, for the respective course unit 104. In an embodiment, the evaluation criteria include different sets of evaluation criteria for different versions of assessment questions, indicated by version numbers and/or dates, for example.

In an embodiment, the learning content 105 and/or the assessment definition data 107 are assigned to one or more defined subjects (e.g. from a list of defined subjects or subject categories).

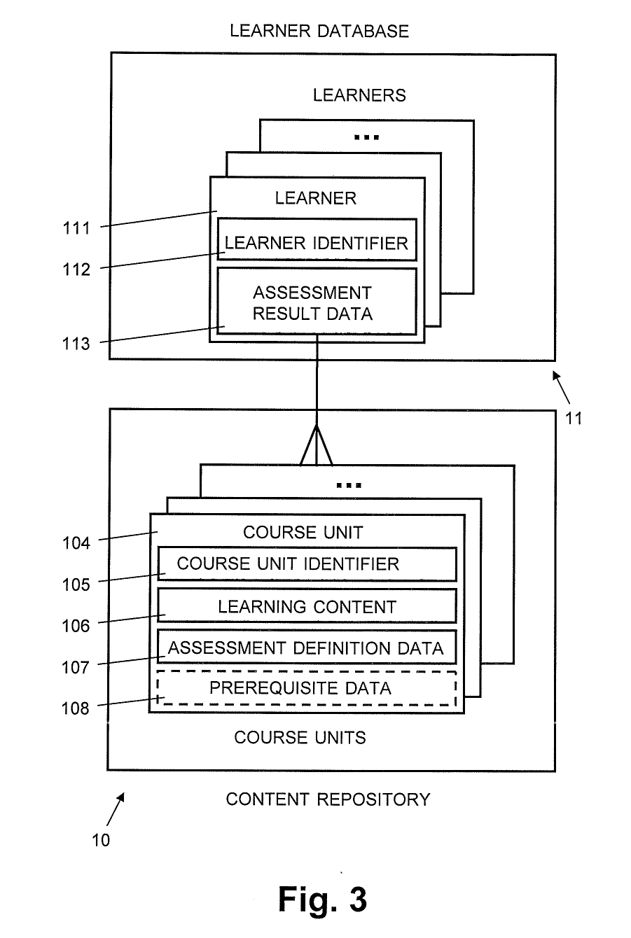

As illustrated in FIG. 3, the learner database 11 includes a plurality of learners 111. Each of the learners 111 includes a learner identifier 112 identifying the learner and assessment result data 113 for one or more course units 104. The learner identifier 112 includes a unique identifier part, e.g. an alphanumeric code, and an optional descriptive part, e.g. a name or nickname. Optionally, the learners 111 include further learner data, such as full name, address, billing information, access control data, e.g. access credentials (password, access code, etc.) and authorized courses, etc. The assessment result data 113 determines a learner's level of achievement. Specifically, the assessment result data 113 determines the level of achievement in one or more the course units 104 of one or more online courses 101. The assessment result data 113 includes the learner's responses to assessment questions for specific course units 104. In an embodiment, the assessment result data 113 includes, as an alternative or in addition, the learner's level of achievement calculated from the learner's assessment responses using the evaluation criteria for the respective course unit 104. In an embodiment, the learner's level of achievement is calculated and stored temporarily, e.g. during an online learning session, in cache memory.

In an embodiment, the assessment result data 113 is assigned to one or more defined subjects (e.g. from a list of defined subjects or subject categories).

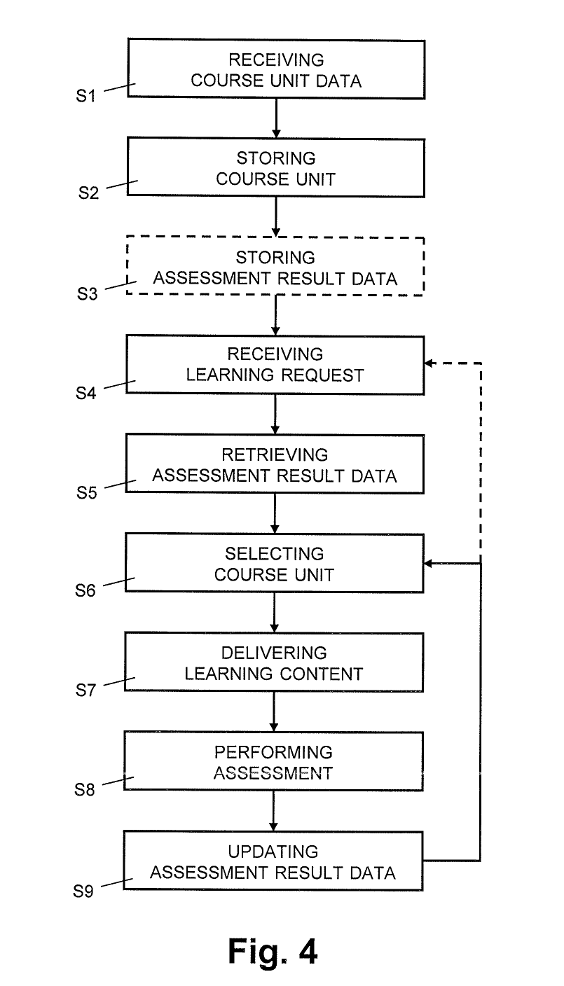

In the following paragraphs, described with reference to FIG. 4 are possible sequences of steps performed by the functional modules of the content repository and delivery system 1 for storing and delivering content for online learning.

In step S1, the authoring module 13 receives from an author or its communication terminal or computer 3, respectively, learning content 106 and assessment definition data 107 for a course unit 104 of an online course 101. The course unit 104 may be assigned explicitly to a particular online course 101 or left unassigned, to be assigned at a later point in time to one or more online courses 101. Once the particular course unit 104 is assigned to a particular online course 101, it may be arranged and positioned in the structure of the online course 101, thereby establishing as prerequisites for the particular course unit 104 those course units 104 that precede the particular course unit 104 in the course structure. Optionally, alternative or additional prerequisite data 108 may be added with the particular course unit 104, e.g. a minimum level of achievement on any preceding or some specific course units 104, or on one or more defined subjects (e.g. from a list of defined subjects or subject categories).

In step S2, the authoring module 13 stores the course unit 104 as a self-contained data object in the content repository 10, including the learning content and assessment definition data, unassigned or assigned to one or more online courses 101.

As outlined above, an online course 101 is a data structure stored in the content repository 10 that includes references 103 to a plurality of course units 104. The authoring module 13 is configured to receive from an author via the telecommunications network 2 requests for including in a particular online course 101 course units that may or may not be already stored in the content repository 10 as a part of another online course 101, and to update the particular online course 101 in the content repository 10 with references 103 to these additional course units 104. The authoring module 13 is further configured to receive from an author via the telecommunications network 2 requests for deleting from a particular online course 101 a particular course unit 104, and to update accordingly in the content repository 10 the references 103 of the particular online course 101 by deleting the corresponding references 103.

In optional step S3, the content repository and delivery system 1 stores for a learner preparatory assessment result data in the learner database 11. The preparatory assessment result data may be derived by way of preparatory screening tests or from school/university transcripts provided by the learner, e.g. tests or transcripts related to one or more defined subjects (e.g. from a list of defined subjects or subject categories).

In step S4, the runtime engine 12 receives a learning request from a learner for a particular online course. The learning request is received via telecommunications network 2 from the communication terminal or computer 4 of the learner. Alternatively, the learning request is received from the learning management system 5. In response to the request from the learning management system 5, the runtime engine 12 generates and transmits to the learning management system 5 an access data object that is configured to enable a learner's computer or communication terminal 4 to transmit to the content repository and delivery system 1 a learning request for the particular online course, e.g. an URL-link (Uniform Resource Locator) or an executable access program. The runtime engine 12 checks and verifies that the requesting learner is authorized to access the particular online course.

In step S5, the runtime engine 12 retrieves from the learner database 11 assessment result data 113 for the authorized learner. Specifically, the runtime engine 12 retrieves assessment result data 113 that is relevant for the requested online course 101. The retrieved assessment result data 113 includes stored assessment responses for course units 104 included and assigned to the requested online course 101. In an embodiment, the assessment result data 113 includes, in addition or alternatively, assessment result data that is related and assigned to one or more defined subjects relevant to the requested online course 101. From the retrieved assessment result data 113, the runtime engine 12 determines the learner's level of achievement relevant for the requested course. Specifically, the runtime engine 12 uses the assessment definition data 107 of the respective course units 104, particularly the evaluation criteria, to calculate or infer the learner's respective level of achievement from the learner's assessment result data 113. For example, for an online course 101 that includes fifteen sequential course units 104 (e.g. course units A-Q), the learner may have achievement levels of 70-90% for six course units (e.g. course units A, B, C, D, E, and F), 55% on one course unit (e.g. course unit G), and 0% on the remaining eight course units 104 (e.g. course units H-Q).

In step S6, the runtime engine 12 selects for the learner's level of achievement, a course unit 104, which is assigned to the requested online course 101. The accessibility of a course unit 104 depends on the structure of the online course 101 and, depending on the embodiment, on optional prerequisite data 108 defined for the course unit 104. Typically, on any sequence of consecutive course units 104, be it on a linear list, a branch of a tree, or a directed graph, a particular course unit 104 is accessible, if the learner has met the required level of achievement on any course units 104 preceding the particular course unit 104. In the example above, access would be granted to course unit H, if a general achievement level of 55% on preceding course units 104 was acceptable, or alternatively, if course unit H did not define a prerequisite higher than 55%. Otherwise, access would be given only to course units A-G, whereby the runtime engine 12 would select course unit G for the learner to continue the requested online course 101 and improve his achievement level.

In step S7, the runtime engine 12 retrieves the selected course unit 104 from the content repository 10 and delivers the learning content 106 via telecommunications network 2 to the learner or its computer or communication terminal 4, respectively.

In step S8, after complete delivery of the learning content to the learner, the runtime engine 12 performs an assessment of the learner with regards to the level of achievement for the course unit 104. For that purpose, the runtime engine 12 uses the assessment definition data 107 and renders to the learner the assessment questions. The runtime engine 12 receives the responses to the assessment questions from the learner or its computer or communication terminal 4, respectively.

In Step S9, the runtime engine 12 updates the assessment result data 113 for the learner, by storing in the learner database 11 the received responses to the assessment questions of the course unit 104.

Subsequently, the runtime engine 12 proceeds in step S4 or S6, by selecting another course unit 104 or receiving a learning request for another online course 101, for example.

It should be noted that, in the description, the computer program code has been associated with specific functional modules and the sequence of the steps has been presented in a specific order, one skilled in the art will understand, however, that the computer program code may be structured differently and that the order of at least some of the steps could be altered, without deviating from the scope of the invention.

1. A computer-implemented content repository and delivery system for online learning, the system comprising:
an authoring module configured to receive from an author via a telecommunications network learning content and assessment definition data for a course unit of an online course, the assessment definition data defining assessment questions and evaluation criteria for assessing a learner's level of achievement with regards to the course unit, and to store the course unit, including the learning content and the assessment definition data, in the content repository as a part of the online course assigned to a course identifier of the online course;
a learner database configured to store for a learner assessment result data assigned to a learner identifier of the learner, the assessment result data determining a learner's level of achievement in course units of the respective online course; and
a runtime engine configured to receive via the telecommunications network a learning request including a particular learner identifier of a particular learner and a particular course identifier, to retrieve from the learner database assessment result data assigned to the particular learner identifier, to select in the content repository for the particular learner's level of achievement, as determined by the assessment result data retrieved from the learner database, a course unit which is assigned to the particular course identifier, to deliver to the learner via the telecommunications network the learning content of the course unit selected in the content repository, to perform an assessment of the learner's level of achievement in the course unit using the respective assessment definition data, and to update in the learner database the assessment result data for the learner, depending on the assessment.

2. The system of claim 1, wherein the runtime engine is configured to store in the learner database as part of the assessment result data for a course unit a learner's responses to assessment questions with regards to the course unit, and to infer from the learner's responses included in the assessment result data retrieved from the learner database the learner's level of achievement, using the evaluation criteria included in the assessment definition data.

3. The system of claim 1, wherein the authoring module is configured to store the course unit as a self-contained data object, and to store an online course as a data structure including references to a plurality of course units.

4. The system of claim 1, wherein the authoring module is further configured to receive from an author via the telecommunications network a request for including in a particular online course an already existing course unit which is stored in the content repository as a part of another online course, and to store the already existing course unit in the content repository further as a part of the particular online course assigned to a course identifier of the particular online course.

5. The system of claim 1, wherein the authoring module is further configured to receive from an author via the telecommunications network a request for adding to or deleting from a particular online course a particular course unit, and to store in the content repository a structure of the particular online course with the particular course unit added or removed, respectively.

6. The system of claim 1, wherein the authoring module is configured to receive from the author via the telecommunications network prerequisite data for a course unit of an online course, the prerequisite data defining prerequisites for the course unit, and to store the course unit including the prerequisite data in the content repository as a part of the online course; and the runtime engine is configured to select in the content repository a course unit which is assigned to the particular course identifier and includes prerequisite data defining prerequisites that are met by the particular learner's level of achievement as determined by the assessment result data retrieved from the learner database.

7. The system of claim 1, further comprising a communication module configured to transmit to a learning management system via the telecommunications network a list of one or more course identifiers of online courses, to receive from the learning management system via the telecommunications network a selection of a particular online course included in the list, and to transmit to the learning management system via the telecommunications network an access data object configured to enable a learner's communication terminal to transmit to the runtime engine via the telecommunications network a learning request including a course identifier of the particular online course.

8. A computer-implemented method of storing and delivering content for online learning, the method comprising:
receiving in a computer-implemented content repository and delivery system from an author via a telecommunications network learning content and assessment definition data for a course unit of an online course, the assessment definition data defining assessment questions and evaluation criteria for assessing a learner's level of achievement with regards to the course unit;
storing in the content repository the course unit including the learning content and the assessment definition data as a part of the online course assigned to a course identifier of the online course;
storing for a learner in a learner database of the computer-implemented content repository and delivery system assessment result data assigned to a learner identifier of the learner, the assessment result data determining a learner's level of achievement in course units of the respective online course;
receiving by a runtime engine of the computer-implemented content repository and delivery system via the telecommunications network a learning request including a particular learner identifier of a particular learner and a particular course identifier;
retrieving by the runtime engine from the learner database assessment result data assigned to the particular learner identifier;
selecting by the runtime engine in the content repository for the particular learner's level of achievement, as determined by the assessment result data retrieved from the learner database, a course unit which is assigned to the particular course identifier;
delivering by the runtime engine to the learner via the telecommunications network the learning content of the course unit selected in the content repository;
performing by the runtime engine an assessment of the learner's level of achievement in the course unit using the respective assessment definition data; and
updating by the runtime engine in the learner database the assessment result data for the learner, depending on the assessment.

9. The method of claim 8, wherein the method further comprises the runtime engine to store in the learner database as part of the assessment result data for a course unit a learner's responses to assessment questions with regards to the course unit, and to infer from the learner's responses included in the assessment result data retrieved from the learner database the learner's level of achievement, using the evaluation criteria included in the assessment definition data.

10. The method of claim 8, wherein the method comprises storing the course unit in the content repository as a self-contained data object, and storing the online course as a data structure including references to a plurality of course units.

11. The method of claim 8, wherein the method further comprises the computer-implemented content repository and delivery system receiving from an author via the telecommunications network a request for including in a particular online course an already existing course unit which is stored in the content repository as a part of another online course, and storing the already existing course unit in the content repository further as a part of the particular online course assigned to a course identifier of the particular online course.

12. The method of claim 8, wherein the method further comprises the computer-implemented content repository and delivery system receiving from an author via the telecommunications network a request for adding to or deleting from a particular online course a particular course unit, and storing in the content repository a structure of the particular online course with the particular course unit added or removed, respectively.

13. The method of claim 8, wherein the method further comprises the authoring module receiving from the author via the telecommunications network prerequisite data for a course unit of an online course, the prerequisite data defining prerequisites for the course unit, the authoring module storing the course unit including the prerequisite data in the content repository as a part of the online course, and the runtime engine selecting in the content repository a course unit which is assigned to the particular course identifier and includes prerequisite data defining prerequisites that are met by the particular learner's level of achievement as determined by the assessment result data retrieved from the learner database.

14. The method of claim 8, wherein the method further comprises the computer-implemented content repository and delivery system transmitting to a learning management system via the telecommunications network a list of one or more course identifiers of online courses, receiving from the learning management system via the telecommunications network a selection of a particular online course included in the list, and transmitting to the learning management system via the telecommunications network an access data object configured to enable a learner's communication terminal to transmit to the runtime engine via the telecommunications network a learning request including a course identifier of the particular online course.

15. A computer program product comprising a non-transient computer readable medium having stored therein computer program code configured to control a processor of a computer-implemented content repository and delivery system, such that the computer-implemented content repository and delivery system performs the steps of:
receiving from an author via a telecommunications network learning content and assessment definition data for a course unit of an online course, the assessment definition data defining assessment questions and evaluation criteria for assessing a learner's level of achievement with regards to the course unit;
storing in the content repository the course unit, including the learning content and the assessment definition data, as a part of the online course assigned to a course identifier of the online course;
storing for a learner in a learner database assessment result data assigned to a learner identifier of the learner, the assessment result data determining a learner's level of achievement in course units of the respective online course;
receiving via the telecommunications network a learning request including a particular learner identifier of a particular learner and a particular course identifier;
retrieving from the learner database assessment result data assigned to the particular learner identifier;
selecting in the content repository for the particular learner's level of achievement, as determined by the assessment result data retrieved from the learner database, a course unit which is assigned to the particular course identifier;
delivering to the learner via the telecommunications network the learning content of the course unit selected in the content repository;
performing an assessment of the learner's level of achievement in the course unit using the respective assessment definition data; and
updating in the learner database the assessment result data for the learner, depending on the assessment.
